(19) United States
(12) Patent Application Publication
(10) Pub. No.: US 2016/0199992 A1
(43) Pub. Date: Jul. 14, 2016

(54) RAZOR CARTRIDGE WITH A PRINTED LUBRICATION MEMBER

(71) Applicant: The Gillette Company, Boston, MA (US)

(72) Inventors: Andrew Charles Nicholas, Winchester, MA (US); Jeffrey Richard Holley, Scituate, MA (US); Matthew Richard Allen, Mason, OH (US); Marco Fontecchio, Framingham, MA (US); Shawn Justin Goldstein, Boston, MA (US)

(21) Appl. No.: 14/964,641

(22) Filed: Dec. 10, 2015

Related U.S. Application Data
(60) Provisional application No. 62/101,010, filed on Jan. 8, 2015.

(51) Int. Cl. B26B 21/44

(52) U.S. Cl. CPC B26B 21/443

(57) ABSTRACT

A razor cartridge including a guard at a front portion of the cartridge, a cap at a back portion of the cartridge, at least one blade positioned between the guard and the cap, a top surface and an opposing bottom surface, and a lubricating member positioned in the cartridge at the top surface. The visible surface of the lubricating member includes a printed object. The printed object appears as a solid object to a viewer's naked eye. The solid object includes a plurality of printed dots not visible to the viewer's naked eye. The printed dots are spaced apart from one another such that portions of the lubricating member within the solid object contain no printed dots.

### FIELD OF THE INVENTION

The invention relates to razors, and more particularly to razor cartridges having lubricating members with printed portions.

### BACKGROUND OF THE INVENTION

The use of shaving aids on razor blades to provide lubrication benefits during the shave is known. See e.g., U.S. Pat. Nos. 7,121,754; 6,298,558; 5,711,076; 5,134,775; 6,301,785; and U.S. Patent Publ. Nos. 2009/0223057 and 2006/0225285. These shaving aids are also commonly referred to as lubrication strips or lubrication members. These types of lubrication strips have been used for years in the shaving industry. The strips are typically extruded making them very cost effective. They may also be extruded in two or more colors to provide both a visual and a functional benefit. The visual benefits being limited by the capabilities of the extruder.

Different structures for delivering lubrication benefits have also been attempted. One such structure is a reservoir that is attached to the razor cartridge. The reservoir contains a lubricant in dry form. The skin engaging surface of the reservoir includes a plurality of apertures. The apertures allow water to enter the reservoir. Upon entering the reservoir, the water interacts with the dry lubricant to create a lubricant which flows out from the reservoir through the apertures to provide a lubricant to the user during shaving. The amount of lubricant delivered to the user during the shave can be determined by the size of the apertures in the reservoir. While such reservoirs do provide the ability to better control the amount of lubricant delivered during the shave, they present the problem of high cost and assembly disadvantages compared to typical lubrication strips.

It is an object of the invention to provide a lubrication member with improved visual appearance over traditional lubrication members while maintaining all the lubrication benefits provided by the lubrication member.

It is an object of the present invention to use a printed visual element on a lubrication member to provide control of the amount of lubricant delivered from the lubricating member to the user during shaving.

### SUMMARY OF THE INVENTION

One aspect of this invention relates to a razor cartridge. The razor cartridge comprises a guard at a front portion of the cartridge, a cap at a back portion of the cartridge, at least one blade positioned between the guard and cap, a top surface, and a lubricating member positioned at the top surface. The lubricating member has a visible surface. A printed object is on the visible surface of the lubricating member. The printed object appears as a solid object to a viewer's naked eye. The solid object comprises a plurality of printed dots not visible to the viewer's naked eye. The printed dots are spaced apart from one another such that portions of the lubricating member within the solid object contain no printed dots.

The portions of the lubricating member within the solid object containing no printed dots are directly exposed to a user's skin during shaving.

The lubricating member may be positioned on the cap, on the guard, both the cap and the guard, and may also form a ring surrounding the blade.

The size of the printed dots may be the same. The spacing between printed dots may be the same.

The size of the printed dots may vary. The spacing between printed dots may vary.

The printed dot may comprise a printed droplet. The printed dot may comprise two or more printed droplets. The printed dot may comprise a UV curable ink.

The printed object on the visible surface of the lubricating member appears as a solid object with a visible boundary to a viewer's naked eye. The solid object comprises a plurality of printed dots not visible to the viewer's naked eye. The printed dots are spaced apart from one another within the visible boundary such that portions of the lubricating member within the visible boundary contain no printed dots.

### BRIEF DESCRIPTION OF THE DRAWINGS

While the specification concludes with claims particularly pointing out and distinctly claiming the subject matter which is regarded as forming the present invention, it is believed that the invention will be better understood from the following description which is taken in conjunction with the accompanying drawings in which like designations are used to designate substantially identical elements, and in which:

FIG. 1 is a perspective view of a razor cartridge of the present invention.

FIG. 2 is a sectional view taken along line 2-2 of FIG. 1.

FIG. 3 is a side elevation view of a lubricating member of the present invention.

FIG. 4 is an enlarged view of a portion of the lubricating member shown in FIG. 1.

FIG. 5 is a side view of a printing process of the present invention.

FIG. 6 is a side view of a printing process of the present invention.

FIG. 7 is a perspective view of another razor cartridge of the present invention.

FIG. 8 is a perspective view of another razor cartridge of the present invention.

FIG. 9 is a plan view of a solid object.

FIG. 10 is a plan view of a solid object.

FIG. 11 is a graph showing overall consumer acceptance scores of two razor cartridges.

FIG. 12 is a plan view of a solid object.

### DETAILED DESCRIPTION OF THE INVENTION

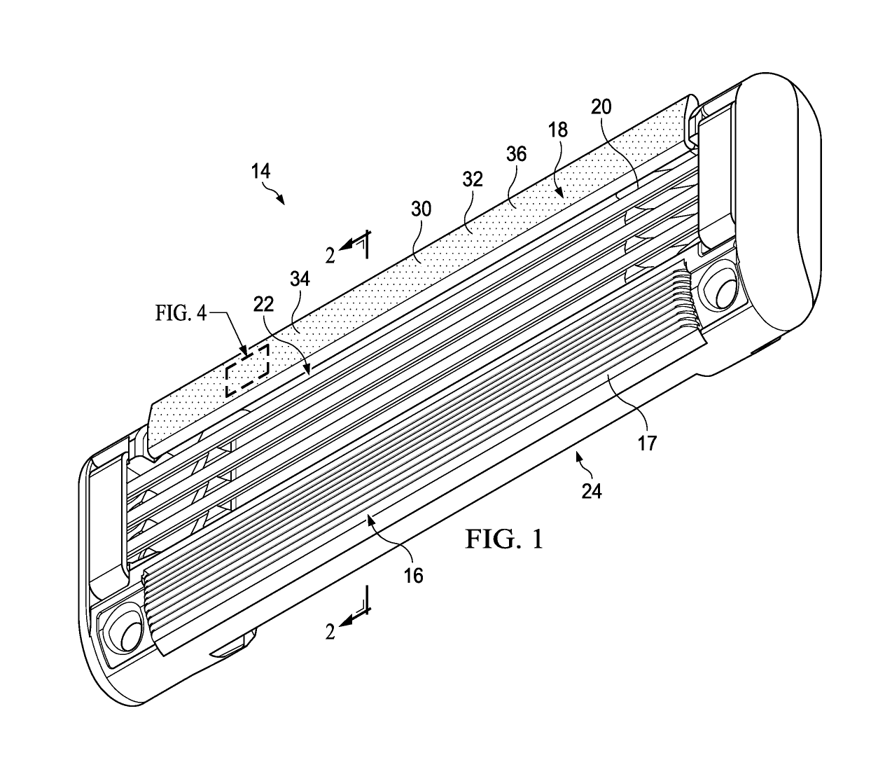

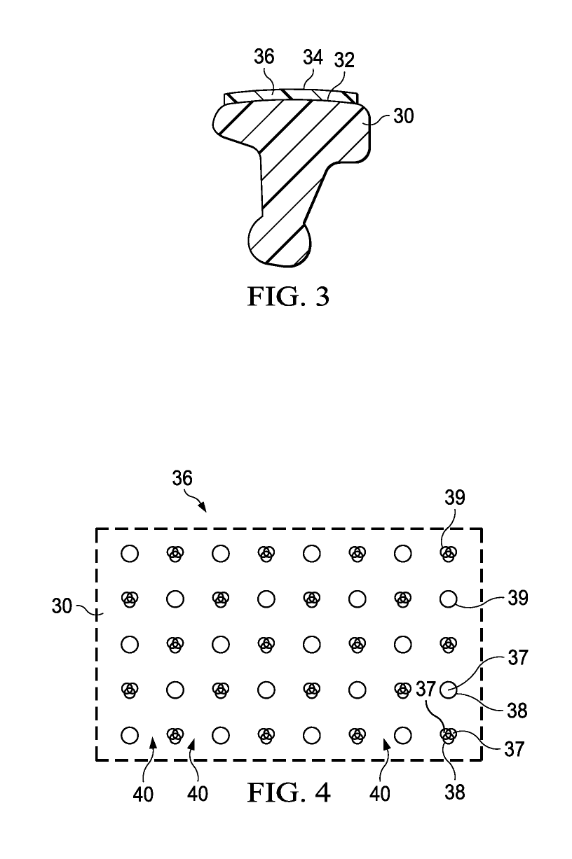

Referring to FIGS. 1-3, the razor cartridge 14 includes a guard 16 positioned at a front portion of the cartridge 14, a cap 18 positioned at a back portion of cartridge 14, and blades 20 positioned between guard 16 and cap 18. Cartridge 14 includes a top surface 22 and an opposing bottom surface 24. A lubricating member 30 is positioned on the top surface 22 of the cartridge 14. Lubricating member 30 has a visible surface 32.

The guard 16 may include one or more elongated flexible protrusions 17 to engage a user's skin. The flexible protrusions 17 include flexible fins generally parallel to the one or more elongated blades 20. In another embodiment, the flexible fins have at least one portion which is not generally parallel to the one or more elongated edges. Non-limiting examples of suitable guards include those used in current razor blades and include those disclosed in U.S. Pat. Nos. 7,607,230 and 7,024,776; (disclosing elastomeric/flexible fin bars); U.S. Publ Nos. 2008/0034590 (disclosing curved guard fins) and 2009/0049695A1 (disclosing an elastomeric guard having a guard forming at least one passage extending between an upper surface and a lower surface).

The lubricating member 30 along with guard 16, cap 18 and blades 20 form the skin engaging portion of the cartridge 14. The lubricating member 30 is preferably locked in (via adhesive, a fitment, or melt bonding) an opening or on a plate or other surface of the cartridge 14.

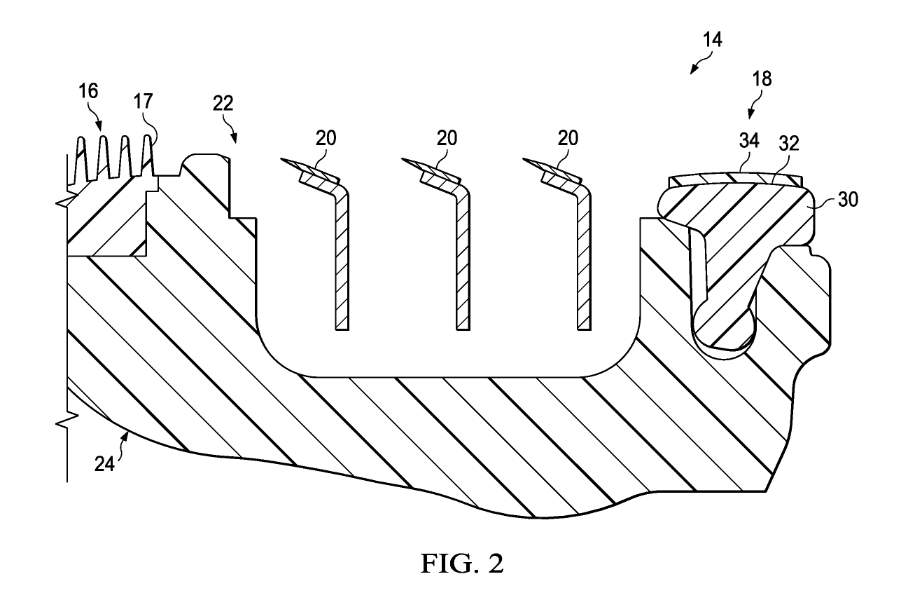

The lubricating member 30 is located on the cartridge such that the lubricating member 30 contacts or engages the skin during the hair removal process, forward and/or aft of the blades and/or along the sides of the cartridge between the forward and aft portions. A feature “forward” of the one or more elongated blade edges, for example, is positioned so that the surface to be treated by the cartridge or hair removal device encounters the feature before it encounters the elongated blade edges. A feature “aft” of the elongated blade edge(s) is positioned so that the surface to be treated by the cartridge or hair removal device encounters the feature after it encounters the elongated blade edges. In FIGS. 1-2 the lubricating member 30 is positioned aft of the blades 20 on the cap 18. Where more than one lubricating member is provided on the cartridge, the lubricating members can be the same or different. By different, meaning having a different size, a different shape, a different composition, and/or a different function.

In one embodiment, the lubricating member 30 comprises a solid polymeric matrix comprising a water-soluble polymer material having a melting point of from about 150° C. to about 250° C. and optionally a water-insoluble polymer material. In one embodiment, the matrix comprises a water soluble polymer comprising at least one of a polyethylene oxide, polyvinyl pyrrolidone, polyacrylamide, polyhydroxymethacrylate, polyvinyl imidazoline, polyethylene glycol, polyvinyl alcohol, polyhydroxyethymethacrylate, silicone polymers, and mixtures thereof. In one embodiment, said water soluble polymer is selected from the group consisting of polyethylene oxide, polyethylene glycol, and a mixture thereof.

The lubricating member 30 may comprise other ingredients commonly found in commercially available lubricating members, such as those used on razor cartridges by Gillette, Schick or BIC. Non-limiting examples of such lubricating members include those disclosed in U.S. Pat. Nos. 6,301,785; 6,442,839; 6,298,558 and 6,302,785, and U.S. Patent Publ Nos. 2008/060201 and 2009/0223057. The lubricating member may also comprise an ingredient selected from the group consisting of polyethylene oxide, polyvinyl pyrrolidone, polyacrylamide, hydroxypropyl cellulose, polyvinyl imidazoline, polyethylene glycol, poly vinyl alcohol, polyhydroxyethylmethacrylate, silicone copolymers, sucrose stearate, vitamin E, soaps, surfactants, panthenol, aloe, plasticizers, such as polyethylene glycol; beard softeners; additional lubricants, such as silicone oil, Teflon® polytetrafluoroethylene powders (manufactured by DuPont), and waxes; essential oils such as menthol, camphor, eugenol, eucalyptol, safrol and methyl salicylate; tackifiers such as Hercules Regalrez 1094 and 1126; non-volatile cooling agents, inclusion complexes of skin-soothing agents with cyclodextrins; fragrances; antipruritic/counterirritant materials; antimicrobial/keratolytic materials such as Resorcinol; anti-inflammatory agents such as Candilla wax and glycyrrhetinic acid; astringents such as zinc sulfate; surfactants such as pluronic and iconol materials; compatibilizers such as styrene-b-EO copolymers; mineral oil, polycaprolactone (PCL), and combinations thereof.

The water-soluble polymer will preferably comprise at least 50%, more preferably at least 60%, by weight of the skin engaging member, up to about 99%, or up to about 90% of the matrix. The more preferred water soluble polymers are the polyethylene oxides generally known as POLYOX (available from Dow or ALKOX (available from Meisei Chemical Works, Kyoto, Japan). These polyethylene oxides will preferably have mol. wt.s of about 100,000 to 6 million, most preferably about 300,000 to 5 million. The most preferred polyethylene oxide comprises a blend of about 40 to 80% of polyethylene oxide having an average mol. wt. of about 5 million (e.g. POLYOX COAGULANT) and about 60 to 20% of polyethylene oxide having an average mol. wt. of about 300,000 (e.g. POLYOX WSR-N-750). The polyethylene oxide blend may also advantageously contain up to about 10% by weight of a low mol. wt. (i.e. MW<10,000) polyethylene glycol such as PEG-100.

The matrix may comprise from about 0.5% to about 50%, preferably from about 1% to about 20%, polycaprolactone (preferably mol. wt. of 30,000 to 60,000 daltons). See U.S. Pat. No. 6,302,785.

The lubricating member may contain other conventional ingredients, such as low mol. wt. water-soluble release enhancing agents such as polyethylene glycol (MW<10,000, e.g., 1-10% by weight PEG-100), water-swellable release enhancing agents such as cross-linked polyacrylics (e.g., 2-7% by weight), colorants, antioxidants, preservatives, vitamin E, aloe, cooling agents, essential oils, beard softeners, astringents, medicinal agents, etc.

The matrix can further comprise a water-insoluble polymer in which the water-soluble polymer is dispersed. Preferably, at a level of from about 0% to about 50%, more preferably about 5% to about 40%, and most preferably about 15% to about 35% by weight of the skin engaging member is a water-insoluble polymer. Suitable water-insoluble polymers which can be used include polyethylene (PE), polypropylene, polystyrene (PS), butadiene-styrene copolymer (e.g. medium and high impact polystyrene), polyacetal, acrylonitrile-butadiene-styrene copolymer, ethylene vinyl acetate copolymer, polyurethane, and blends thereof such as polypropylene/polystyrene blend or polystyrene/impact polystyrene blend.

One preferred water-insoluble polymer is polystyrene, preferably a general purpose polystyrene or a high impact polystyrene such as Styrenics 5410 from Ineos (i.e. polystyrene-butadiene), such as BASF 495F KG21. The water-insoluble polymer provides mechanical strength to the lubricating member for production and during use.

The lubricating member may be made by extrusion or another high temperature processing, such as injection molding, compacting, ultrasonic or radio frequency sintering, and slot coating.

The blended components of the lubricating member may be extruded through a Haake System 90, ¾ inch diameter extruder with a barrel pressure of about 1000-2000 psi, a rotor speed of about 10 to 50 rpm, and a temperature of about 150°-185° C. and a die temperature of about 170°-185° C. Alternatively, a 1¼ inch single screw extruder may be employed with a processing temperature of 175°-200° C., preferably 185°-190° C., a screw speed of 20 to 50 rpm, preferably 25 to 35 rpm, and an extrusion pressure of 1800 to 5000 psi, preferably 2000 to 3500 psi. The extruded strip is air cooled to about 25° C. To injection mold the strips it is preferred to first extrude the powder blend into pellets. This can be done on a 1¼ or 1½ inch single screw extruder at a temperature of 120°-180° C., preferably 140°-150° C., with a screw speed of 20 to 100 rpm, preferably 45 to 70 rpm. The pellets are then molded in either a single material molding or multi-material molding machine, which may be single cavity or multi-cavity, optionally equipped with a hot-runner system. The process temperature can be from 165° to 250° C., preferably from 180° to 225° C. The injection pressure should be sufficient to fill the part completely without flashing. Depending on the cavity size, configuration and quantity, the injection pressure can range from 300 to 2500 psi. The cycle time is dependent on the same parameters and can range from 3 to 30 seconds, with the optimum generally being about 6 to 15 seconds. In one embodiment, one or more feeds can be preheated or they can be fed in at ambient temperature.

In one embodiment, the lubricating member is attached to the cartridge via a carrier. The lubricating member can be a molded soap formulation and can be integrally formed (meaning they are formed in the same process, such as where they are both cast together in a single mold) with the carrier, or not integrally formed (meaning the lubricating member can be attached to the carrier via a mechanical attachment, such as where the lubricating member is molded or otherwise fitted around a retaining portion of the carrier, or bonded via adhesive or heat). Non-limiting examples of suitable lubricating members include the soap wings present on Venus Breeze® line of 2-in-1 razor, and/or the moisturizing solid on the Schick® Intuition® line of razors. In one embodiment, the lubricating member and carrier can resemble the shaving aids and shaving aid holders disclosed in U.S. Patent Publ. Nos. 2006/225285A and 2006/080837A, and/or U.S. Pat. No. 7,811,553.

The visible surface 32 of lubricating member 30 includes a printed object 34. The printed object 34 shown in FIGS. 1-3 is an object covering the entire visible surface 32 of lubricating member 30. The printed object 34 may cover only a portion or portions of the visible surface 32 of lubricating member 30. The printed object 34 appears as a solid object 36 to a viewer's naked eye when the perpendicular distance between the viewer's eye and the visible surface is about 30 centimeters. When a viewer looks at the visible surface 32 of lubricating member 30 they see a solid object 36 and do not see or visually perceive any of the underlying lubrication member 30.

Referring now to FIG. 4, solid object 36 comprises a plurality of individual printed dots 38. The individual printed dots 38 are spaced apart from one another such that free portions 40 of lubricating member 30 within the solid object 36 contain no printed dots 38. That is, adjacent individual printed dots 38 are spaced apart from one another such that adjacent individual printed dots 38 do not touch one another. When adjacent individual printed dots 38 are spaced apart from one another the periphery 39 of adjacent individual printed dots 38 do not overlap or touch one another creating free portions 40 of lubricating member 30. Free portions 40 contain no printed dots 38 leaving free portions 40 exposed to the external environment. Each printed dot 38 may be comprised of a single printed droplet 37 or may be comprised of two or more, i.e., several, many, numerous, printed droplets 37 which together form a single individual printed dot 38.

During shaving free portions 40 of lubricating member 30 are directly exposed to the shaving environment which includes water, shave preps and skin. This direct exposure to the shaving environment allows for the release of lubricant or soluble constituent from the lubricating member 30 a phenomenon typically referred to as leaching. This leaching from the very first shave is important to provide the desired lubrication benefits throughout the intended use of the cartridge 14, such as shown in FIG. 1. In contrast, if the solid objects were constructed of solid printing coverage with not a single free portion, the user would first need to wear through the ink to eventually expose the underlying lubricating member. With the absence of free portions the benefits provided by the lubricating member would not be realized on the first or subsequent shaves until the printed portion was worn away to expose the underlying lubricating member. The size, number and/or spacing of printed dots 38 control the amount of lubricant delivered to the user during the shave. Fewer and/or smaller printed dots 38 with greater spacing between printed dots 38 results in greater and faster delivery of lubricant to the user during the shave. More and/or larger printed dots with less spacing between printed dots 38 results in less and slower delivery of lubricant to the user during the shave.

A printed dot 38 made of a single printed droplet 37 will wear away faster compared to a printed dot 38 made of multiple printed droplets 37 having the same dimensions as the single printed droplet.

The size of the printed dots 38 may be consistent throughout the solid object 36. The size of the printed dots 38 may vary throughout the solid object. The spacing between printed dots 38 may be consistent throughout the solid object 36. The spacing between printed dots 38 may vary throughout the solid object 36. For example, it may be desirable to have the size of the printed dots 38 larger and/or the spacing between printed dots 38 smaller near the periphery of the solid object so as minimize the flow of lubricant near the periphery. It may be desirable to have the size of the printed dots 38 smaller and/or the spacing between printed dots 38 larger near the center of the solid object so as to increase the flow of lubricant.

The size of the printed droplets 37 may be consistent throughout the solid object 36. The size of the printed droplets 37 may vary throughout the solid object.

The printed dots may be applied with a suitable type of device including, but not limited to print heads, nozzles, and other types of material deposition devices. Any suitable type of print heads can be used including, but not limited to ink jet print heads. In certain embodiments, the deposition device is an ink jet print head. The print heads may be of a non-contacting, digital type of deposition device. By “non-contacting”, it is meant that the print heads do not contact the surface to be printed. By “digital”, it is meant that the print heads can apply droplets of ink only where needed such as to form a pattern in the form of words, figures (e.g., pictures), or designs.

Ink jet print heads will typically comprise multiple nozzles. The nozzles are generally aligned in rows and are configured to jet ink in a particular direction that is generally parallel to that of the other nozzles. The nozzles within each row on a print head can be aligned linearly. Alternatively, the nozzles may be in one or more rows that are oriented diagonally relative to the longer dimension (or length) of the print head. Both such arrangements of nozzles can be considered to be substantially linearly arrayed. The ink jet print heads can comprise any suitable number and arrangement of nozzles therein. One suitable ink jet print head contains approximately 360 nozzles per inch (per 2.54 cm). The Xaar 1001 is an example of a suitable print head for use herein, and is available from Xaar of Cambridge, UK.

The droplets of ink can range in diameter from about 10 microns or less to about 200 microns, or more. The droplets of ink can be distributed in any suitable number over a given area. Typically, in ink jet printing, the ink droplets form a matrix in which the number of drops per inch (DPI) is specified in the direction of movement of the print head or article to be printed, and in a direction on the surface of the article perpendicular thereto. The application of ink droplets provided on the surface of the lubricating member to form a solid image can range from about 80, or less up to about 2,880 or more droplets per inch (DPI) in at least one direction.

The apparatus can comprise a printing apparatus with any suitable number, arrangement, and type of print heads. For example, the apparatus may comprise between 1-20, or more, print heads. The print heads may be arranged in a spaced apart relationship. Alternatively, one or more of the print heads may be positioned adjacent and in contact with another one of the print heads.

If there is more than one print head, the different print heads can print cyan, magenta, yellow, and black or any other combination of desired colors.

The ink of the present invention is preferably a ultra-violet (UV) curable ink. UV curable inks are generally monomer/oligomer based with photosensitive molecules that initiate a polymerization reaction (e.g. curing) when exposed to UV light. This reaction is near instantaneous once the ink lands on a substrate. The cross linking that occurs during curing provides a durable ink with good adhesion to the substrate.

Suitable types of UV curable ink that may be used include free radical and cationic. Both free radical and cationic UV inks are cured when exposed to UV light. When free radical inks are exposed to UV light a photoinitiator absorbs the UV light generating free radicals which react with double bonds causing chain reaction and polymerization. When cationic inks are exposed to UV light a photoinitiator absorbs the UV light generating a Lewis acid which reacts with epoxy groups resulting in polymerization.

Other types of UV curable inks may also be used. Examples of such UV curable inks include but are not limited to hybrid UV/water inks and hybrid UV/oil inks.

The high cure rates of UV curable inks translate into very high operating speeds. Thus, UV curable inks can be advantageously run on high-speed production equipment without having to allow for excessively large dryers, as would be necessary for other ink systems. The rapid cure rate also allows UV curable inks to be used to provide multiple layers in succession without having to move the substrate after each layer. This in turn allows for elevation, structuring, texturing, and colors to be easily incorporated.

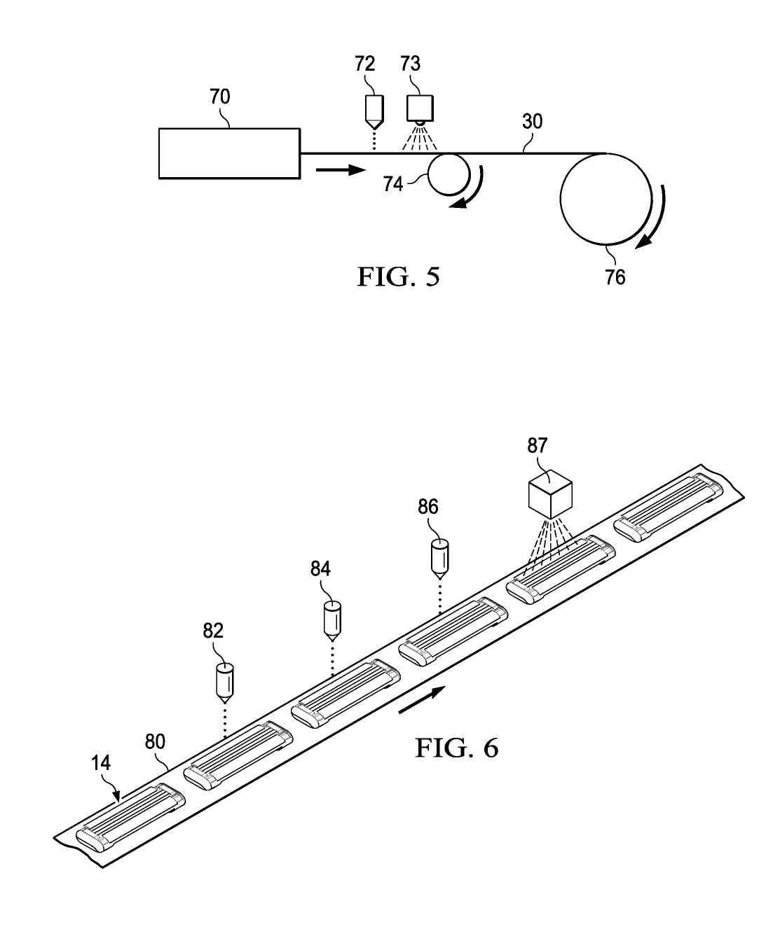

Referring to FIG. 5, there is shown an extruder 70 extruding a lubricating member 30. Printing station 72 containing multiple print heads prints ink in the form of droplets 37 on lubricating member 30, such as shown in FIG. 4. A light unit 73 directs UV light toward lubricating member 30 to cure the ink. Lubricating member 30 is supported by roller 74 until taken up by wind up roll 76.

Referring to FIG. 6, there is shown a web 80 carrying independent cartridges 14 such as shown in FIG. 1. Cartridges 14 pass under print stations 82, 84 and 86 which print ink in the form of droplets 37 on lubricating member 30 such as shown in FIG. 4. A light unit 87 directs UV light toward cartridge 14 to cure the ink. Cartridges 14 can then be passed to the next processing station by web 80.

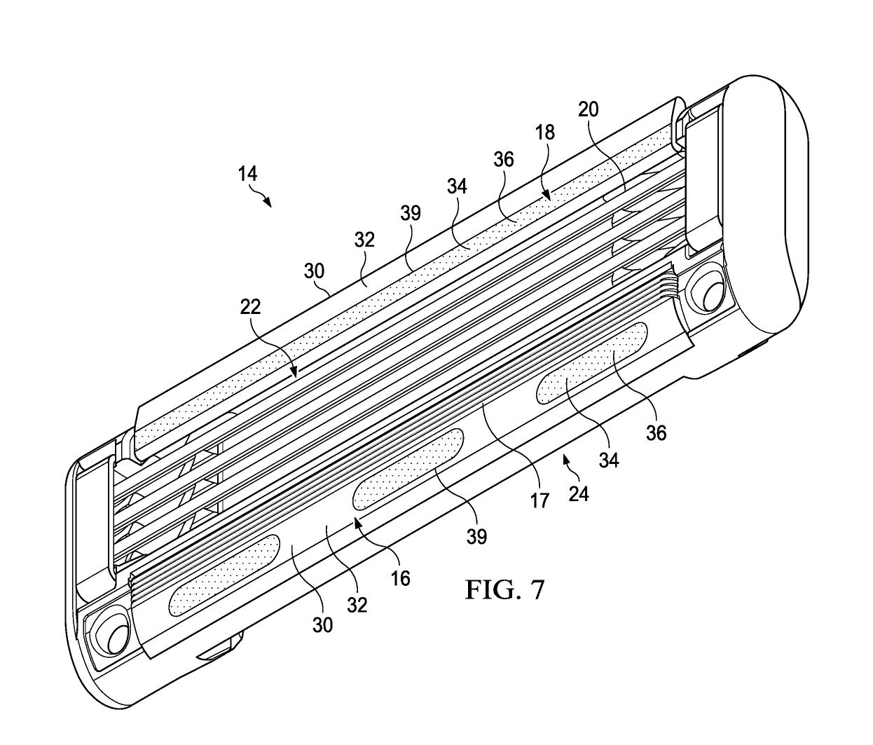

Referring to FIG. 7, the razor cartridge 14 includes a guard 16 positioned at a front portion of the cartridge 14, a cap 18 positioned at a back portion of cartridge 14, and blades 20 positioned between guard 16 and cap 18. Cartridge 14 includes a top surface 22 and an opposing bottom surface 24. Lubricating members 30 are positioned on the top surface 22 of the cartridge 14. Lubricating members 30 each have a visible surface 32. The guard 16 includes flexible protrusions 17 in the form of flexible fins extending generally parallel to the one or more elongated blades 20.

The lubricating members 30 along with guard 16, cap 18 and blades 20 form skin engaging portions of the cartridge 14. The lubricating members 30 are located on the cartridge such that the lubricating members 30 contact or engage the skin during the hair removal process. The lubricating members 30 are positioned both forward and aft of the blades 20. The lubricating members 30 are positioned on the guard 16 and cap 18, respectively.

The visible surfaces 32 of lubricating members 30 include printed objects 34. The printed object 34 on the cap 18 is in the form of a continuous strip extending along the length of the visible surface 32 of lubricating member 30. The printed object 34 on the guard is in the form of spaced apart segments positioned along the length of the visible surface 32 of lubricating member 30. The printed objects 34 appear as solid objects 36 to a viewer's naked eye when the perpendicular distance between the viewer's eye and the visible surface is about 30 centimeters. The printed objects 34 have a visible boundary 39. Visible boundary 39 defines the shape and size of the printed object 34 clearly separating it from adjacent unprinted portions of lubricating member 30.

As shown in FIG. 4, solid objects 36 comprise a plurality of individual printed dots 38. The individual printed dots 38 are spaced apart from one another such that free portions 40 of lubricating member 30 within the solid object 36 contain no printed dots 38. That is, adjacent individual printed dots 38 are spaced apart from one another such that adjacent individual printed dots 38 do not touch one another. When adjacent individual dots 38 are spaced apart from one another the periphery 39 of adjacent individual printed dots 38 do not overlap or touch one another creating free portions 40 of lubricating member 30. Free portions 40 contain no printed dots leaving free portions 40 exposed to the external environment. Each printed dot 38 may be comprised of a single printed droplet 37 or may be comprised of two or more, i.e., several, many, numerous, printed droplets 37 which together form a single individual printed dot 38.

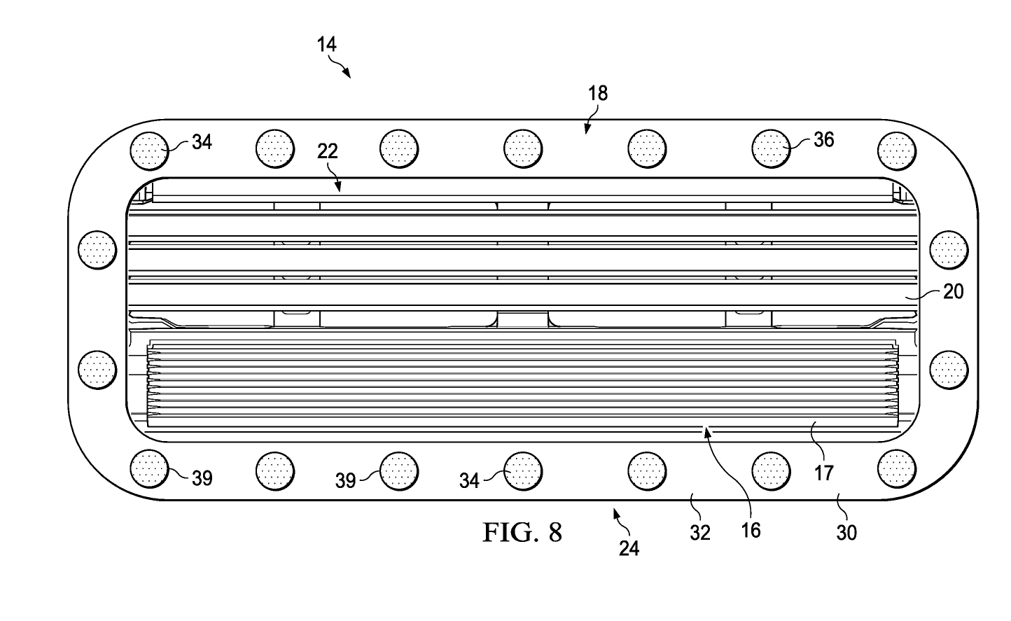

Referring to FIG. 8, the razor cartridge 14 includes a guard 16 positioned at a front portion of the cartridge 14, a cap 18 positioned at a back portion of cartridge 14, and blades 20 positioned between guard 16 and cap 18. Cartridge 14 includes a top surface 22 and an opposing bottom surface 24. Lubricating member 30 is positioned on the top surface 22 of the cartridge 14. Lubricating member 30 has a visible surface 32. The guard 16 includes flexible protrusions 17 in the form of flexible fins extending generally parallel to the one or more elongated blades 20.

The lubricating member 30 along with guard 16, cap 18 and blades 20 form the skin engaging portion of the cartridge 14. The lubricating member 30 is located on the cartridge such that the lubricating member 30 contacts or engages the skin during the hair removal process. The lubricating member 30 is the form of a ring surrounding blades 20.

The visible surfaces 32 of lubricating members 30 include printed objects 34. The printed objects 34 on the visible surface of lubricating member 30 are in the form of spaced apart solid circles. The printed objects 34 appear as solid objects 36 to a viewer's naked eye when the perpendicular distance between the viewer's eye and the visible surface is about 30 centimeters. The printed objects 34 have a visible boundary 39. Visible boundary 39 defines the shape and size of the printed object 34 clearly separating it for adjacent unprinted portions of lubricating member 30.

As shown in FIG. 4, solid objects 36 comprise a plurality of individual printed dots 38. The individual printed dots 38 are spaced apart from one another such that free portions 40 of lubricating member 30 within the solid object 36 contain no printed dots 38. That is, adjacent individual printed dots 38 are spaced apart from one another such that adjacent individual printed dots 38 do not touch one another. When adjacent individual printed dots 38 are spaced apart from one another the periphery 39 of adjacent individual printed dots 38 do not overlap or touch one another creating free portions 40 of lubricating member 30. Free portions 40 contain no printed dots leaving free portions 40 exposed to the external environment. Each printed dot 38 may be comprised of a single printed droplet 37 or may be comprised of two or more, i.e.; several, many, numerous, printed droplets 37 which together form a single printed dot 38.

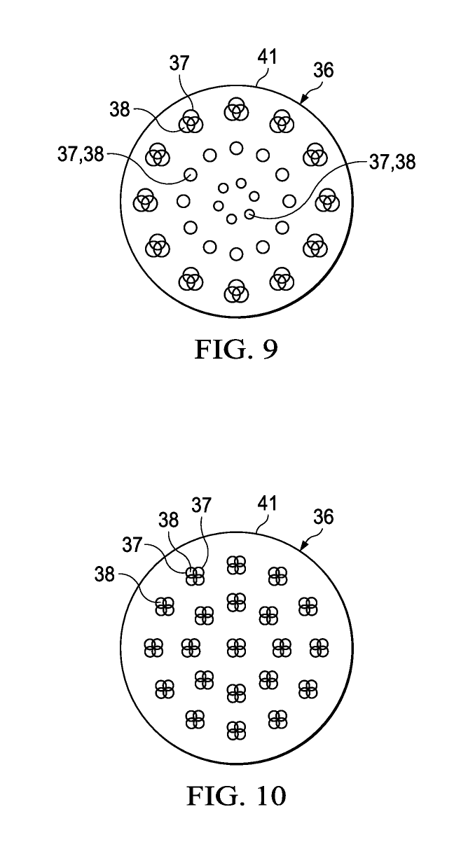

Referring now to FIG. 9 there is shown a solid object 36 having a boundary 41. As can be seen the size of the printed dots 38 near the boundary are larger than printed dots near the center of solid object 36. The spacing between adjacent printed dots 38 is smaller near the boundary 41 than the spacing between printed dots 38 near the center of the solid object 36. The printed dots 38 near the boundary 41 comprise three droplets 37. The printed dots 38 near the center comprise a single droplet 37. The printed dots 38 between the center and boundary comprise a single droplet 37 having a size and or area larger than the droplets near the center.

Referring now to FIG. 10 there is shown a solid object 36 having a boundary 41. As can be seen the size of the printed dots 38 is the same throughout the solid object 36. The spacing between adjacent printed dots 38 is the same throughout the solid object 36. The printed dots 38 comprise four droplets.

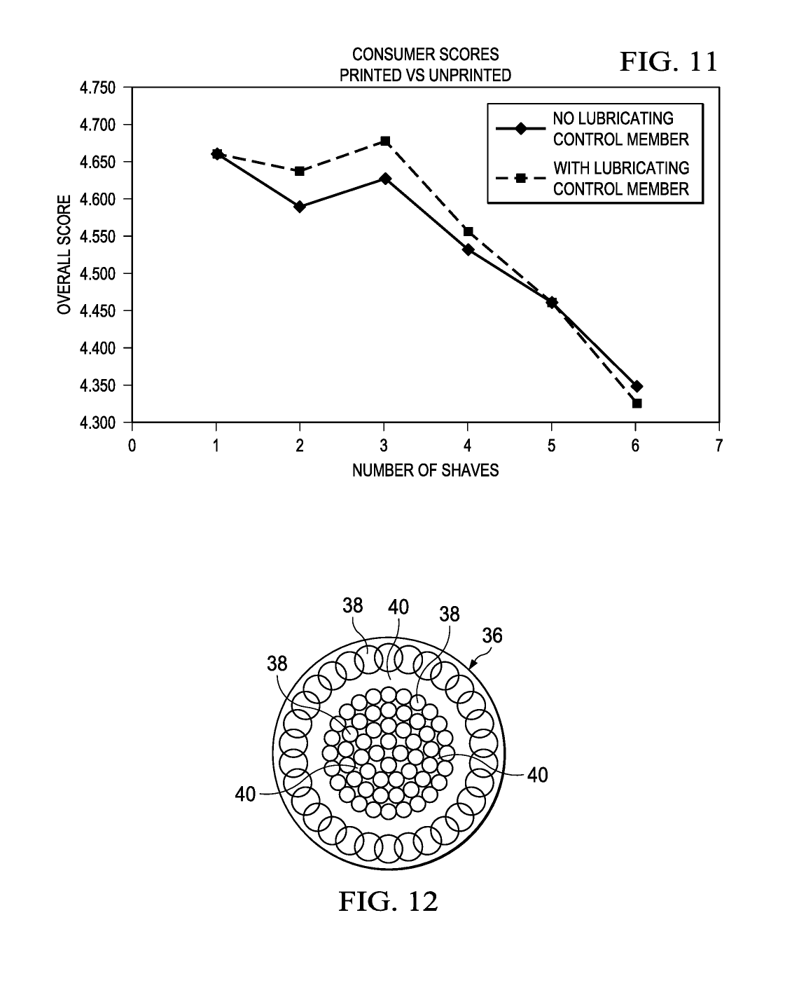

A cartridge with a printed object was tested with consumers. In the test forty panelists were asked to shave with two different cartridges. Both cartridges were of the same configuration and contained the same lubricating member formula. The lubricating member contained 23.6% of a low mol wt polyethylene oxide having an average mol wt of less than 1 million to about 100,000 Da, 5.0% polyethylene glycol, 27.0% ethylene vinyl acetate with 12% vinyl acetate, 4.0% white colorant, 35.40% of a high mol wt polyethylene oxide having an average mol wt of about 2 million to 10 million Da, and 5.0% polycaprolactone. In the first cartridge the lubricating member contained no printed object. In the second cartridge the lubricating member was printed with a solid object covering the entire visible surface of the lubricating member similar to that shown in FIG. 1. The printed object while appearing solid to the user had individual printed dots covering 25% of the visible surface area of the lubricating member. Each panelist was asked to shave each cartridge six shaves and rate the overall performance of each shave. The results of the test are shown in FIG. 11. As can be seen, the two products performed at near parity with each other.

As shown in FIG. 12, solid object 36 comprises a plurality of individual printed dots 38. Some of the adjacent individual printed dots 38 overlap each other leaving no free portions between adjacent printed dots while some of the adjacent individual printed dots 38 are spaced apart from one another such that free portions 40 within the solid object 36 contain no printed dots 38. That is, some adjacent individual printed dots 38 are spaced apart from one another such that adjacent individual printed dots 38 do not touch one another while some adjacent individual printed dots overlap each other. When adjacent individual printed dots 38 are spaced apart from one another the periphery of adjacent individual printed dots 38 do not overlap or touch one another creating free portions 40. Free portions 40 contain no printed dots leaving free portions 40 exposed to the external environment.

It should be understood that every maximum numerical limitation given throughout this specification includes every lower numerical limitation, as if such lower numerical limitations were expressly written herein. Every minimum numerical limitation given throughout this specification includes every higher numerical limitation, as if such higher numerical limitations were expressly written herein. Every numerical range given throughout this specification includes every narrower numerical range that falls within such broader numerical range, as if such narrower numerical ranges were all expressly written herein.

All parts, ratios, and percentages herein, in the Specification, Examples, and Claims, are by weight and all numerical limits are used with the normal degree of accuracy afforded by the art, unless otherwise specified.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A razor cartridge comprising;
a. a guard at a front portion of said cartridge, a cap at a back portion of said cartridge, at least one blade positioned between said guard and said cap, a top surface, and a lubricating member positioned at said top surface, said lubricating member having a visible surface;
b. a printed object on said visible surface of said lubricating member, said printed object appearing as a solid object to a viewers naked eye, said solid object comprising a plurality of printed dots not visible to the viewers naked eye, said printed dots spaced apart from one another such that portions of said lubricating member within said solid object contain no printed dots.

2. The razor cartridge of claim 1, wherein the portions of said lubricating member within said solid object containing no printed dots are directly exposed to a user's skin during shaving.

3. The razor cartridge of claim 1, wherein said lubricating member is positioned on said cap.

4. The razor cartridge of claim 1, wherein said lubricating member is positioned on said guard.

5. The razor cartridge of claim 1, wherein said lubricating member is a ring surrounding said blade.

6. The razor cartridge of claim 1, wherein the size of the printed dots are the same.

7. The razor cartridge of claim 1, wherein the spacing between printed dots is the same.

8. The razor cartridge of claim 1, wherein the size of the printed dots varies.

9. The razor cartridge of claim 1, wherein the spacing between printed dots varies.

10. The razor cartridge of claim 1, wherein the printed dot comprises a printed droplet.

11. The razor cartridge of claim 1, wherein the printed dot comprises two or more printed droplets.

12. The razor cartridge of claim 1, wherein the printed dot comprises a UV curable ink.

13. A razor cartridge comprising;
a. a guard at a front portion of said cartridge, a cap at a back portion of said cartridge, at least one blade positioned between said guard and said cap, a top surface, and a lubricating member positioned at said top surface, said lubricating member having a visible surface;
b. a printed object on said visible surface of said lubricating member, said printed object appearing as a solid object with a visible boundary to a viewers naked eye, said solid object comprising a plurality of printed dots not visible to the viewers naked eye, said printed dots spaced apart from one another within said visible boundary such that portions of said lubricating member within said visible boundary contain no printed dots.

14. The razor cartridge of claim 13, wherein the portions of said lubricating member within said visible boundary containing no printed dots are directly exposed to a user's skin during shaving.

15. The razor cartridge of claim 13, wherein said lubricating member is positioned on said cap.

16. The razor cartridge of claim 13, wherein said lubricating member is positioned on said guard.

17. The razor cartridge of claim 13, wherein said lubricating member is a ring surrounding said blade.

18. The razor cartridge of claim 13, wherein the size of the printed dots are the same.

19. The razor cartridge of claim 13, wherein the spacing between printed dots is the same.

20. The razor cartridge of claim 13, wherein the printed dot comprises a printed droplet.
